(19) United States
(12) Patent Application Publication
(10) Pub. No.: US 2009/0066625 A1
(43) Pub. Date: Mar. 12, 2009

(54) Electronic newspaper

(76) Inventor: Joseph M. Jacobson, Newton Center, MA (US)

Correspondence Address: MARTIN D. MOYNIHAN d/b/a PRTSI, INC., P.O. BOX 16446, ARLINGTON, VA, 22215, US

(21) Appl. No.: 11/898,429

(22) Filed: Sep. 12, 2007

(51) Int. Cl. G09G 3/36

(52) U.S. Cl. 345/92

(57) ABSTRACT

We describe an electronic newspaper system which comprises an electronic newspaper device further comprising a low power flexible display, a radio for receiving information, a processor for processing said information for display and manipulation, memory for storing information and a battery for storing power in communication with a remote computer server capable of aggregating newspaper content and transmitting said content to said device. Additional aspects may include input means for inputting information, a back channel radio for sending information out and tracking means for tracking the position of the newspaper device. A further additional aspect of the invention comprises a business means comprising an electronic marketplace for electronic newspaper content.

### RELATED APPLICATION

This application claims the benefit of U.S. Provisional Application No. 60/84x,xxx filed Sep. 17, 2006, the contents of which are incorporated herein by reference.

### BACKGROUND

Currently newspapers are still printed onto paper and physically delivered to the subscriber. This means of information dissemination is inefficient in material (e.g. the cost of the physical paper and the printing and delivery of the paper) as we as in time. An alternative means of information delivery is via the internet which is efficient in both material and time. That being said many readers find that reading of the news via the internet is non-optimal either because their internet connection is through a desktop computer which is physically less convenient to read, or is through a laptop which requires significant time to boot up and is somewhat heavy or is through a mobile device such as a PDA which has a small viewing screen. Here we describe an electronic newspaper hereinafter called the ‘newspaper device’ which significantly overcomes the above limitations.

### BRIEF DESCRIPTION OF THE INVENTION

The disclosure describes a preferred embodiment of an electronic newspaper which is equipped with a low power display, a radio for receiving information, a processor for processing said information for display and manipulation, memory for storing information and a battery for storing power. Additional aspects may include input means for inputting information and a back channel radio for sending information out. A further additional aspect of the invention comprises a business means further comprising a marketplace for content which is dissemenatable on the newspaper device.

### DETAILED DESCRIPTION OF THE DRAWINGS

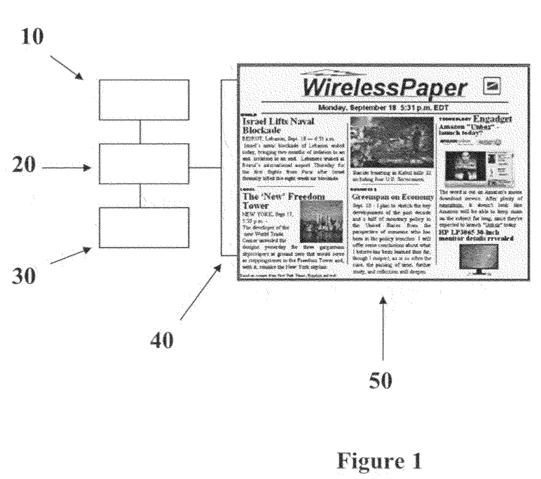

FIG. 1. Schematic drawing of the electronic newspaper device.

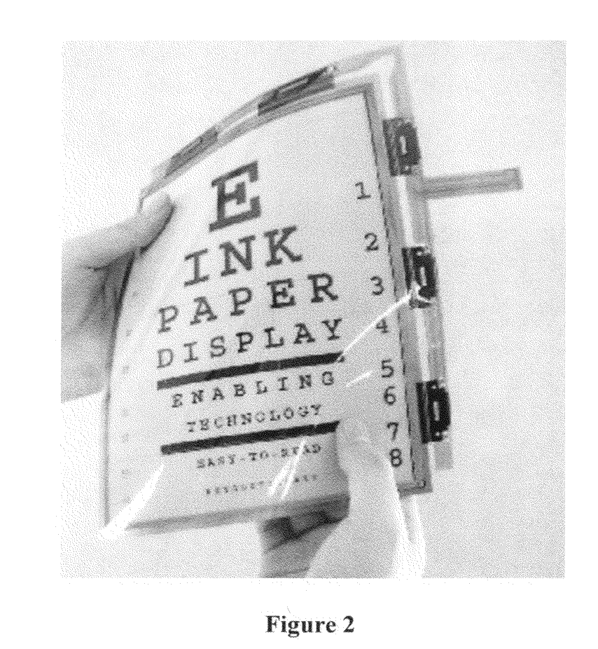

FIG. 2. Photograph of a flexible display

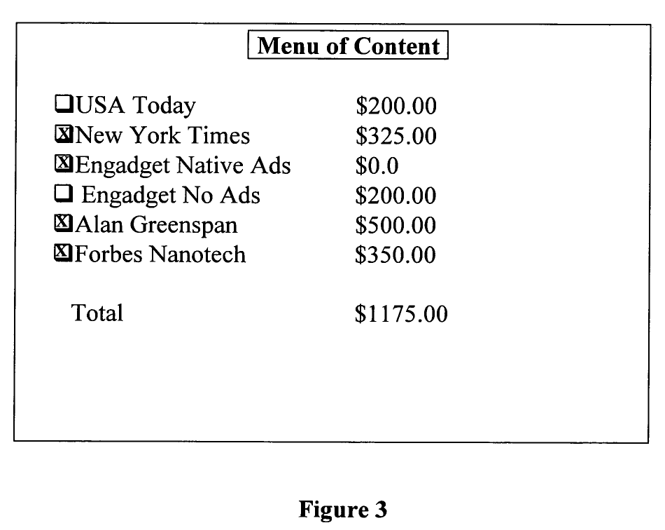

FIG. 3. Schematic showing business mean further comprising a marketplace for content.

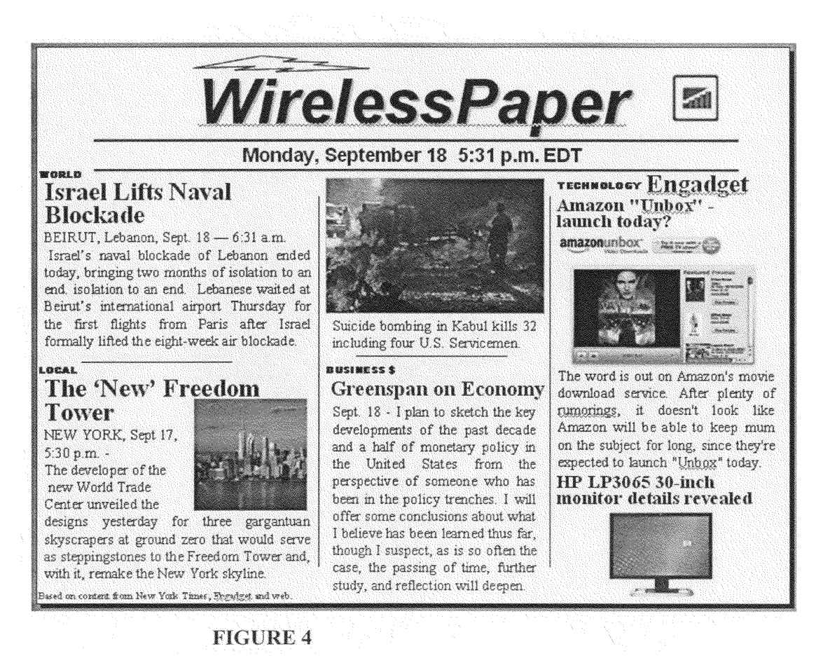

FIG. 4. Screen shot of the electronic newspaper device.

### DETAILED DESCRIPTION OF THE INVENTION

Referring to FIG. 1 is the schematic of an electronic newspaper device comprising in a preferred embodiment a flexible display 50 with associated display drivers 40, a microprocessor 20 and additionally comprising a radio 10 which may be a two way radio both receiving incoming data and transmitting outgoing data and memory 30. Said radio may be GPRS, EDGE, EVDO, Wifi or an FM sideband. Such a device automatically receives and displays transmitted news and information feeds which may be RSS feeds as are known in the art. As described below the user can define which information content is received by the device and displayed to the user by means of a web interface typically running on another web connected computer but which may in certain instances be run on the newspaper device. Additional aspects of the electronic newspaper device may include a touch screen or other input means to select or manipulate various content.

FIG. 2 shows an example of a flexible display made by a collaboration between E Ink corporation and LG. Philips in which an E Ink display surface is combined with a flexible TFT backplane. Flexible displays can be manufactured by carrying out PECVD deposition of Silicon on flexible substrates such as plastic or metal foils or by ink-jetting or depositing by other means the appropriate semiconductor, metallic and insulating materials which comprise TFT devices. Such semiconductors can either be organic materials or inorganic materials as has been demonstrated in the art of printed electronics. In a preferred embodiment, such a flexible display serves as the low cost, light weight and low power display of the newspaper device.

FIG. 3 shows a screen shot of a web application for choosing content to be transmitted and displayed on the newspaper device. The web application comprises a marketplace for newspaper device content. Information providers may post content choices to the web application. Some of this content may be free, some may have a subscription fee associated with it and some content may come in a free form with embedded native ads or a cost bearing form generally free of ads. The user may select all of the content which they wish to post to their device. The total for this content is automatically tallied and the user is automatically billed. Certain radio services will allow the location of the device to be tracked and thus certain types of content, such as local weather or news can be automatically directed to the user's device depending on where their device is located.

FIG. 4 shows a screen shot of the electronic newspaper device showing several types of mixed content including national and local news, paid financial information and a web feed.

We claim:

1. An electronic newspaper system comprising an electronic newspaper device further comprising a flexible display and a data receiving radio in communication with a remote serving computer capable of aggregating newspaper content and transmitting said content to said device.

2. The system of claim 1 in which said newspaper device additionally comprises electronic memory.

3. The system of claim 1 in which said newspaper device additionally comprises a touch screen.

4. The system of claim 1 in which said remote serving computer additionally has a web interface by which content authors may transmit content and by which electronic newspaper users may select content for transmission to said electronic newspaper device.

5. The system of claim 4 further comprising an automated billing system in which the costs for selected content are automatically tallied and billed.

6. The system of claim 1 in which said newspaper content comprises advertisements.

7. The system of claim 1 in which said electronic newspaper device additionally comprises a transmitting radio.

8. The system of claim 1 additionally comprising means for gathering position data of said electronic newspaper device and means for using said position data to cause position dependent content to be displayed in said electronic newspaper device.

9. The system of claim 1 additionally comprising means for tagging said newspaper content with location specific tags such that said tagged content may be preferentially displayed on said electronic newspaper devices within certain locations.
